(19) United States
(12) Patent Application Publication
(10) Pub. No.: US 2007/0167324 A1
(43) Pub. Date: Jul. 19, 2007

(54) Erasable paper product

(76) Inventor: Mike S.D. Juang, Vancouver, WA (US)

Correspondence Address: KLARQUIST SPARKMAN, LLP, 121 SW SALMON STREET, SUITE 1600, PORTLAND, OR, 97204, US

(21) Appl. No.: 10/590,826

(22) PCT Filed: Feb. 25, 2005
(86) PCT No.: PCT/US05/05971

§ 371 Date: Aug. 23, 2006

Related U.S. Application Data
(60) Provisional application No. 60/548,591, filed on Feb. 26, 2004.
(60) Provisional application No. 60/585,874, filed on Jul. 6, 2004.

(51) Int. Cl. B32B 29/00; B41M 5/20

(52) U.S. Cl. 503/200; 428/537.5

(57) ABSTRACT

A paper product comprising a base sheet and a marking-erasable coating is disclosed. The base sheet can comprise a base-sheet core and a base-sheet coating. The marking-erasable coating is water soluble or water dispersible and can include, for example, various natural or modified starches applied at a coating weight sufficient to make the surface of the paper product erasable. The paper product can be substantially recyclable or substantially repulpable. Also described is a method for making the paper product.

### CROSS REFERENCE TO RELATED APPLICATIONS

This application claims the benefit of U.S. Provisional Patent Application No. 60/548,591, filed Feb. 26, 2004, and U.S. Provisional Patent Application No. 60/585,874, filed Jul. 6, 2004, both of which are incorporated herein by reference.

### FIELD

This invention concerns paper products, particularly erasable paper products.

### BACKGROUND

Erasable surfaces, in general, are surfaces to which liquid ink can be applied and then removed with relative ease and without causing significant surface damage. Products that incorporate erasable surfaces, such as dry erasable boards, can be marked, erased, and remarked multiple times. The degree of erasability often depends on the type of ink used to mark the erasable surface and on the surface to which the ink is applied. Some inks are more erasable than others. Special marking instruments are known that are designed for erasability when used on erasable surfaces.

Several known products have erasable surfaces. These products typically comprise a support and a coating. For example, dry erasable boards typically comprise a firm support that is coated with a material that is resistant to ink absorption and adsorption. Conventional coatings include various plastics and fluorinated organic compounds, such as polytetrafluoroethene. At least some of the materials used in products with erasable surfaces, particularly the materials used in the coatings on these products, are not compatible with certain commonly used recycling and repulping processes. For example, the plastic films that often are used to impart surfaces with erasable qualities typically are resistant to degradation in aqueous solutions. These films can remain substantially intact during at least some commonly used recycling and repulping processes. Intact films can clog machinery and generally interfere with the uniformity of the recycled or repulped material.

Some products that are designed to resist staining also may be erasable. For example, it is known to use fluorine-based treatments for creating cloth surfaces that resist staining. At least some of these fluorine-based treatments, however, may pose a serious health risk.

There is a need for a paper product with an erasable surface that is compatible with a large number of recycling and repulping processes and is less toxic than conventional products with erasable surfaces.

### SUMMARY

Described herein are embodiments of a substantially erasable paper product. Also described are embodiments of a method for making this paper product. Some disclosed embodiments are configured so that liquid ink from a colored marker, particularly a black dry erase marker, can be applied to the surface of the paper product, allowed to dry, and then erased with a dry cloth, such that the marker density is reduced from greater than about 0.5 to less than about 0.1. In addition to being erasable, some disclosed embodiments of the paper product also are substantially recyclable or substantially repulpable. Some disclosed embodiments also have high oil and grease resistance. For example, some disclosed embodiments have an oil and grease resistance between 9 and 12 or between 10 and 12 based on the 3M oil and grease test kit.

The disclosed embodiments of the paper product include a marking-erasable coating, such as a water-soluble or water-dispersible marking-erasable coating. In some disclosed embodiments, the marking-erasable coating is substantially continuous. The marking-erasable coating can comprise a variety of ingredients, such as starches, cellulose, charged polymers, derivatives thereof, and mixtures thereof. In some disclosed embodiments, the marking-erasable coating comprises an effective amount of pearl corn starch, pea starch, ethylated starch, carboxyl methylated starch, cationic potato starch, styrene butadiene grafted starch, modified food grade tapioca starch, carboxymethylcellulose, hydroxyethylcellulose, sodium alginate, polyvinyl alcohol, or mixtures thereof. Starch is a preferred ingredient, so some disclosed embodiments comprise greater than about 50% starch.

In addition to a marking-erasable coating, the disclosed paper product comprises a base sheet. The base sheet comprises a base-sheet core comprising a network of fibers and, optionally, a base-sheet coating, such as a base-sheet coating comprising a pigment and a binder. The base-sheet coating can be present, for example, in an amount varying from about 2 pounds per 3,000 ft² to about 20 pounds per 3,000 ft².

The marking-erasable coating typically is present in an amount sufficient to make the paper product erasable. The exact coating weight of the marking-erasable coating often is dependent on whether the base sheet comprises a base-sheet coating. Where a base-sheet coating is present, the marking-erasable coating can be present, for example, in an amount varying from about 0.3 pounds per 3,000 ft² to about 8 pounds per 3,000 ft². Where a base-sheet coating is not present, the marking-erasable coating can be present, for example, in an amount varying from about 2 pounds per 3,000 ft² to about 15 pounds per 3,000 ft².

One purpose of the base-sheet coating is to enhance the appearance of the paper product, such as by whitening the paper product. Thus, the base-sheet coating typically comprises a pigment. Most pigments, however, comprise particles that readily absorb ink. Pigments can be detrimental to erasability when surfaces of the pigment particles are left exposed on the surface of the paper product. Therefore, some embodiments of the paper product include a marking-erasable coating having a substantially continuous surface that contains substantially no surface-exposed pigment particles. Such marking-erasable coatings can be obtained, for example, by including no pigment in the marking-erasable coating. Alternatively, pigment can be included in the marking-erasable coating, but in an amount sufficiently small so as not affect the continuity of the marking-erasable coating surface. The pigment also can be distributed in the marking-erasable coating cross-section such that the pigment particles are not exposed at the surface of the marking-erasable coating. When a base-sheet coating comprising a pigment and a binder is present, the marking-erasable coating, for example, can comprise less than about 30% pigment. If no base-sheet coating is present, the marking-erasable coating can include a higher amount of pigment, for example, from about 2% to about 50% pigment.

The physical properties of the disclosed paper product can affect its erasability. Greater density and smoothness generally improve erasability. Some disclosed embodiments have a Gurley density greater than about 1,000 seconds and/or a Sheffield smoothness less than about 200 cubic centimeters per minute.

One way to modify the physical properties of the paper product is by calendering the paper product. Calendering can be performed at various stages in the papermaking process. In some embodiments of the method for making the paper product, the base sheet is calendered before applying the marking-erasable coating until the base sheet has a Gurley density greater than about 75 seconds. Similarly, some embodiments comprise calendering the paper product after applying the marking-erasable coating until the paper product has a Gurley density greater than about 1,000 seconds or a Sheffield smoothness less than about 200 cubic centimeters per minute.

Embodiments of the disclosed paper product can be incorporated into a variety of useful products, including kits, easel pads, and note paper products. The kits can include, for example, writing instruments that can be used to create erasable marks on the paper product and erasers that can be used to erase marks made on the paper product by the writing instrument. Some note paper products can be made with surfaces at least partially covered with an adhesive material.

### BRIEF DESCRIPTION OF THE DRAWINGS

FIG. 1 is a cross-sectional schematic view of an embodiment of the disclosed paper product comprising a base sheet and a marking-erasable coating.

FIG. 2 is a cross-sectional schematic view of an embodiment of the disclosed paper product comprising a base sheet and a marking-erasable coating, where the base sheet comprises a base-sheet core and a base-sheet coating.

FIG. 3 is a plan view of the second surface of an erasable note paper product, a portion of which includes an adhesive.

### DETAILED DISCUSSION

The following terms may be abbreviated in this disclosure: cubic centimeters (cc), marking-erasable coating (MEC), feet squared (ft²), marker density (MD), minutes (min), pounds per linear inch (pli), pounds per square inch (psi), residual marker density (RMD), and seconds (sec).

Unless otherwise explained, all technical and scientific terms used herein have the same meaning as commonly understood by one of ordinary skill in the art to which this disclosure belongs. The singular terms “a,” “an,” and “the” include plural referents unless context clearly indicates otherwise. Similarly, the word “or” is intended to include “and” unless the context clearly indicates otherwise. The term “comprises” means “includes.” All coating weights recited herein are dry coating weights unless indicated otherwise. Similarly, the percentages of various components in the coatings are dry weight percents unless indicated otherwise.

Disclosed herein are embodiments of a paper product, embodiments of a method for making the paper product, and embodiments of the paper product modified for a variety of applications. The disclosed paper product is erasable and also can be recyclable or repulpable.

### Erasable

The disclosed paper product is designed so that at least some inks applied in a liquid form can be erased. Erasability can be achieved, for example, by preventing ink from being absorbed by or otherwise penetrating through at least a portion of the surface of the paper product. If applied ink is isolated on the surface of the paper product, it can be removed more easily. By way of providing a theory of operation, and not to limit the invention, it has been observed that inks applied to surfaces having limited porosity do not significantly penetrate those surfaces and hence are more likely to be erasable. The porosity of a surface may be affected by various factors and combinations of such factors, including the characteristics of the surface coating, the characteristics of the underlying layer(s), and processing parameters, such as coating amounts and calendering pressures.

Erasability is further improved if the ink does not adsorb to or otherwise significantly bond with the surface of the paper product. Such bonding can occur, for example, as a result of interactions between the ink and the surface material. A useable paper product, however, must hold ink sufficiently well to allow the paper product to be marked by a marking instrument. In preferred embodiments, ink can be applied to the surface of the paper product by a marking instrument to produce visible marks and the applied ink generally will remain on the surface of the paper product until it is removed by an affirmative step.

Several different techniques can be used for erasing marks from the surface of the disclosed paper product. The appropriate technique often depends on the type of ink used to make the mark. Marks made with dry erase markers, such as EXPO® markers, typically can be erased with a dry cloth. In contrast, erasing marks made by permanent markers sometimes requires the use of a rubbery eraser.

Residual marker density (RMD) can be used to quantify erasability. RMD is the density of a marker image after it is erased from a surface, such as after wiping the surface with a dry cloth or rubbing the surface with a rubbery eraser. RMD can be measured, for example, with a densitometer, such as an X-Rite densitometer. RMD values below 0.1 are desirable. The marker density (MD) of an image before erasure varies depending on the color, with typical marker densities ranging from about 0.5 to about 1.76. After being applied, allowed to dry, and then immediately erased from embodiments of the disclosed paper product, marks made by a black dry erase marker typically have RMD values less than about 0.2, such as between about 0.02 and about 0.2, typically less than about 0. 1, such as between about 0.02 and about 0.1, and even more typically less than about 0.07, such as between about 0.02 and about 0.07.

Several characteristics of the paper product affect its erasability, including its density. Some disclosed embodiments have a Gurley density greater than about 1,000 seconds, typically greater than about 5,000 seconds, and even more typically greater than about 10,000 seconds. The smoothness of the surface of the paper product also is important in promoting erasability. Some disclosed embodiments have a Sheffield smoothness less than about 200 cc/min, typically less than about 80 cc/min, and even more typically less than about 50 cc/min.

Some disclosed embodiments are designed so that applied ink will eventually become non-erasable. For example, liquid ink applied to some disclosed embodiments will only be erasable with an RMD less than 0.2 for an erasability period beginning immediately after the ink is applied. The erasability period can be, for example, between about 5 minutes and about 12 hours, typically between about 10 minutes and about 6 hours, and even more typically between about 15 minutes and about 3 hours. In some of these embodiments, if the ink is left on the surface for longer than 12 hours, it will become permanent with an RMD, for example, greater than about 0.5, typically greater than about 0.6, and even more typically greater than about 0.7.

Some embodiments of the disclosed paper product are erasable even though they are not compatible with all ink types. For example, some disclosed embodiments are erasable if some particular inks, or classes of inks, can be removed while other inks or classes of inks cannot easily be removed. Some embodiments of the paper product are not compatible with water-based inks because they can partially dissolve the marking-erasable coating.

### Oil and Grease Resistance

In addition to being erasable, some embodiments of the disclosed paper product have a high degree of oil and grease resistance. By way of theory, oil and grease resistance is promoted by hydrophilic coating materials with good film-forming properties. Coatings containing these materials tend to resist penetration by hydrophobic oil and grease molecules. Many of the materials disclosed herein for promoting erasability also promote oil and grease resistance.

Oil and grease resistance is commonly measured with an oil and grease test kit available from 3M (St. Paul, Minn.). This test kit contains a series of solutions, each containing different concentrations of caster oil, toluene and n-heptane. The concentrations of these components in each of the numbered test kit solutions are provided in Table 1.

TABLE 1

| Solution No. | Castor Oil % | Toluene % | n-Heptane % |
|---|---|---|---|
| 1 | 100 | 0 | 0 |
| 2 | 90 | 5 | 5 |
| 3 | 80 | 10 | 10 |
| 4 | 70 | 15 | 15 |
| 5 | 60 | 20 | 20 |
| 6 | 50 | 25 | 25 |
| 7 | 40 | 30 | 30 |
| 8 | 30 | 35 | 35 |
| 9 | 20 | 40 | 40 |
| 10 | 10 | 45 | 45 |
| 11 | 0 | 50 | 50 |
| 12 | 0 | 45 | 55 |

Generally, it is more difficult for paper products to resist penetration by the test kit solutions containing higher concentrations of the solvents toluene and n-heptane. As seen in Table 1, the concentrations of these solvents are higher in the higher numbered solutions. Some embodiments of the disclosed paper product have oil and grease resistance between 9 and 12 or between 10 and 12 based on the 3M oil and grease test kit. This means that these embodiments meet or exceed a threshold resistance to penetration by test kit solutions 1 through 9 or 1 through 10, respectively.

### Recyclable

Some embodiments of the disclosed paper product are recyclable. Recyclable paper products are compatible with most conventional, standard, or high-volume paper recycling processes. Some disclosed embodiments can be recycled along with newspaper, notebook paper, and magazine paper. Many factors affect whether a paper product is recyclable. Some disclosed embodiments are recyclable because they do not contain a substantial amount of certain materials. Examples of materials that are incompatible with most conventional, standard, or high-volume paper recycling processes include, but are not limited to, certain non-polar polymeric materials, certain solid materials with high melting points and certain highly toxic materials. Some embodiments of the paper product are recyclable because they do not contain certain structural components, such as plastic films that are not water soluble or water dispersible.

### Repulpable

Some embodiments of the paper product are repulpable. Repulpable paper products are compatible with most conventional paper repulping processes. Paper repulping processes typically involve fewer process steps when compared to recycling processes. For example, some conventional repulping processes break down the material to be repulped merely by soaking the material in water with moderate agitation. Some of the disclosed embodiments are repulpable because they comprise ingredients and components that are water soluble or water dispersible. Some of these embodiments are reduced to pulp when soaked in water. Other embodiments are broken down by water in conjunction with heating or mild chemicals, such as chemicals that disperse cellulose.

### Components of the Paper Product

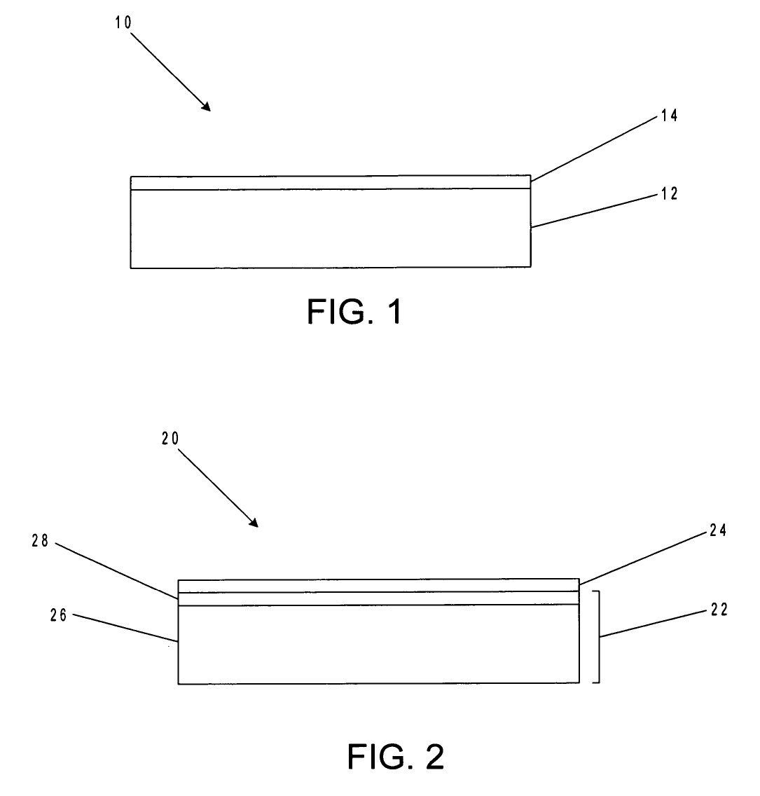

The disclosed paper product comprises a base sheet and a marking-erasable coating. For example, the paper product 10 illustrated in FIG. 1 comprises a base sheet 12 and a marking-erasable coating 14 disposed on at least one surface of the base sheet 12. In some disclosed embodiments, the base sheet comprises a base-sheet core and a base-sheet coating. For example, the paper product 20 illustrated in FIG. 2 comprises a base sheet 22 and a marking-erasable coating 24. The base sheet 22 comprises a base-sheet core 26 and a base-sheet coating 28 disposed on a surface of the base-sheet core 26. The marking-erasable coating 24 is disposed on a surface of the base-sheet coating 28.

The Base Sleet

The first step in creating an erasable paper product is the selection of a base sheet. A variety of base sheets can be used in erasable paper product embodiments, but some base sheets promote erasability more than others. If the base sheet is particularly porous, coatings applied to the base sheet and the final surface of the paper product are more likely to be non-uniform. Non-uniform surfaces are more likely to absorb ink and generally are not well suited for erasability. In contrast, base sheets with limited porosity tend to inhibit ink absorption. The porosity of a base sheet depends on the composition of the base sheet and the processing of the base sheet. Porosity is related to density in that denser base sheets tend to be less porous. Some embodiments of the disclosed paper product comprise a base sheet with a Gurley density greater than about 75 seconds, typically greater than about 150 seconds, and even more typically greater than about 300 seconds.

Calendering is a process step that can reduce the porosity of the base sheet by increasing the density of the base sheet. Calendered base sheets, in general, are denser, less porous, smoother, and more uniform than non-calendered base sheets. This effect can be increased by calendering the base sheets multiple times or by calendering the base sheets at higher pressures. Excessive pressure, however, can cause base sheets to become too thin. In some disclosed embodiments, the base sheet is calendered at a pressure varying from about 100 pli to about 800 pli, typically from about 100 pli to about 500 pli, and even more typically from about 100 pli to about 350 pli. Several calendering techniques are acceptable for reducing the porosity of the base sheet, including super calendering and hot/soft calendering. Since porosity tends to inhibit erasability, calendered base sheets provide a superior erasable product when all other factors are equal.

In embodiments of the disclosed paper product, the base sheet comprises a network of fibers. These fibers can be natural fibers (such as wood fibers, cotton fibers, or straw fibers), synthetic fibers (such as glass fibers, nylon fibers, or polyester fibers), or combinations of natural and synthetic fibers. Natural fibers can be bleached to increase their whiteness. Some recyclable or repulpable embodiments of the paper product contain less than about 70% synthetic fibers, typically less than about 50% synthetic fibers, and even more typically less than about 10% synthetic fibers.

Since base sheets comprise fibers, it is possible for these fibers to protrude from the base-sheet surface. This phenomenon is sometimes referred to as “fuzzing.” Protruding fibers can interfere with the uniformity of subsequent coatings. For example, the protruding fibers can extend through subsequent coatings and then break off creating voids in the coatings. Protruding fibers therefore can have a negative effect on the erasability of some paper products.

In addition to fibers, the base sheets in some embodiments of the paper product can comprise one or more other materials, such as binders, fillers, sizing agents, and pigments. These materials can be mixed with the fibers or applied to the surface of the fibers in one or more base-sheet coatings. Binders are used to hold base-sheet coatings together or to hold base-sheet coatings to the fibers. Examples of binders include starch, latex, and polyvinyl alcohol. Fillers can be used to reduce the amount of fiber in a paper product and thereby reduce the cost of raw materials. Fillers also can be used to reduce shrinkage, to adjust pH, to promote smoothness, to increase opacity, to increase whiteness, and to promote dispersal of the fibers in repulping processes. Calcium carbonate is an example of a suitable filler material. Sizing is added primarily to encase the fibers and thereby reduce bleeding. Examples of materials that can be used as sizing include starch, alum, rosin, gelatin, alkenyl succinic anhydride, alkyl ketene dimer, and various polymers. Pigments primarily are used to improve the appearance of the product, such as to increase the whiteness of the product. Most pigments are granular solids and also can serve as important structural components of base-sheet coatings. Suitable pigments include clay, calcium carbonate, titanium dioxide, and various plastic pigments.

In certain embodiments, the base sheet comprises a base-sheet coating, such as a base-sheet coating comprising at least a pigment and a binder. Base-sheet coatings are particularly effective at suppressing fuzzing and otherwise providing a smooth base-sheet surface. The presence of a base-sheet coating also makes it easier to apply the marking-erasable coating. Base-sheet coatings alone, however, do not make a paper product erasable. By way of theory, this may be because base-sheet coatings have surface-exposed pigment particles that absorb ink. Base-sheet coatings also may be discontinuous and thereby allow the paper product to be penetrated by liquid inks. The continuity of some base-sheet coatings, for example, may be disrupted by the presence of pigment particles.

The base-sheet coating can be applied in an amount sufficient to coat the fibers on the surface of the base-sheet core. For example, the base-sheet coating can be applied in an amount sufficient to prevent fuzzing. This can be a dry coating weight, for example, varying from about 2 pounds per 3,000 ft² to about 20 pounds per 3,000 ft², typically from about 3 pounds per 3,000 ft² to about 15 pounds per 3,000 ft², and even more typically from about 4 pounds per 3,000 ft² to about 12 pounds per ft².

Base sheets can be made from raw materials or purchased from a paper supplier. Suitable base sheets for making embodiments of the paper product include coated off set paper, release base paper, face label paper, and food grade paper. All of these base sheet types are available from one or more of the following suppliers: OfficeMax, Inc. (Itasca, Ill.), Boise Cascade, LLC (Boise, Id.) or Boise White Paper, LLC (Boise, Id.).

The Marking-Erasable Coating

After selecting a suitable base sheet, the base sheet then can be engineered to increase its erasability. One way to modify the erasability of a base sheet is to apply one or more coatings. These coatings, which are applied over the base-sheet coating, if present, can be referred to as marking-erasable coatings. The effectiveness of a particular coating material is partially dependent on two criteria. First, the material should be capable of forming films, and hence useful for coating paper products. Second, the material should resist solvent absorption or adsorption for applied inks, that is, the material should have good “solvent hold out.” Some conventional coatings may exhibit these properties, but for certain applications it also is desirable to use coatings that are water soluble or water dispersible, for example, to facilitate recyclability or repulpability. Conventional coatings used to enhance erasability, such as non-polar wax coatings and polymer laminates, are not water soluble or water dispersible.

A substantially continuous marking-erasable coating promotes erasability. Such a coating can be substantially free of exposed liquid absorbing particles, such as pigment particles. By way of theory, continuity in the marking-erasable coating(s) helps to prevent applied ink from absorbing into the paper product. Therefore, coatings that have a tendency to crack (such as when dried or handled), are generally inferior to coatings that do not crack. Coatings that generally do not crack tend to be coatings that comprise materials that are somewhat flexible when dry.

Several water soluble or water dispersible coating materials have been discovered that are surprisingly effective at promoting erasability. For example, some water soluble or water dispersible materials are polar and do not mix well with the nonpolar organic solvents that are commonly used to carry ink in writing instruments. These polar materials often are well suited for isolating ink on the surface of paper products.

In some disclosed embodiments, the marking-erasable coating comprises an effective amount of one or more of the following: starches (including, but not limited to, pearl corn starch, pea starch, ethylated starch, carboxyl methylated starch, cationic potato starch, styrene butadiene grafted starch, and modified food grade tapioca starch), cellulose (including, but not limited to, cellulose derivatives, such as carboxymethylcellulose and hydroxyethylcellulose), charged polymers (including, but not limited to, sodium alginate), and polyvinyl alcohol (including, but not limited to fully hydrolyzed and partially hydrolyzed polyvinyl alcohol). Each of these materials has been discovered to impart erasability without interfering with the paper product's recyclability or repulpability.

Starches are particularly well-suited materials for incorporation into a marking-erasable coating. Starches typically are inexpensive, substantially non-toxic (or at least relatively non-toxic compared to fluorinated organic compounds), and very effective at promoting erasability. One preferred marking-erasable coating comprises greater than about 50% starch, typically greater than about 70% starch, and even more typically greater than about 90% starch. The family of useful starches includes a variety of polysaccharides, including starches in their natural form and modified starches. Most natural starches are derived from plant products, including, but not limited to, corn, potatoes, wheat, rice, and combinations thereof. Starches can be modified, for example, by acidifying, ethylation, esterifying, or oxidizing.

In contrast to the materials described above, several materials were found to absorb ink and inhibit erasability, at least when present in significant quantities and exposed to the surface of the paper product. These chemicals include gum arabic, xanthan gum, styrene butadiene, polyvinyl acetate, ethylene vinyl acetate, certain acrylic polymers, polyethylene glycol, polyoxyethylene, and polyvinylpyrrolidone. Other chemicals were found to inhibit erasability only when present in greater quantities in the marking-erasable coating. These chemicals include clay, calcium carbonate, titanium dioxide, and several other pigments. When used in small portions and mixed with chemicals that do not promote erasability, these chemicals often have a negligible effect on erasability. In some disclosed embodiments, these chemicals are incorporated in the marking-erasable coating in small amounts to act, for example, as binders or coating extenders.

Most of the materials found to be useful for enhancing the erasability of the paper product were characterized by the ability to form continuous films and the presence of strong hydrogen bonding between the material's molecules or polymer chains. It was discovered that films formed with charged chemicals, including certain modified starches and cellulose, had particularly strong solvent hold out. By way of theory, the ionic properties of these chemicals may promote solvent hold out.

Embodiments of the disclosed paper product can be made in which the marking-erasable coating comprises a single ingredient, such as starch. The marking-erasable coating also can comprise ingredients that do not substantially affect erasability or, as discussed above, ingredients that have a negative effect on erasability. These ingredients typically are added in small quantities for specific purposes. For example, some disclosed embodiments have marking-erasable coatings that comprise pigments, binders, or fillers.

The use of a pigment in the marking-erasable coating is particularly helpful if the paper product does not have a base-sheet coating. Pigments that whiten the marking-erasable coating are useful because whiter surfaces contrast more effectively with applied inks. Pigments, however, typically absorb ink and disrupt the continuity of the marking-erasable coating. In embodiments of the paper product that comprise a base-sheet coating comprising a pigment and a binder, the marker-erasable coating typically comprises less than about 30% of any pigment, such as less than about 20% pigment or less than about 10% pigment. In embodiments of the paper product that do not comprise a base-sheet coating, the marker-erasable coating can have a concentration of pigment varying, for example, from about 2% to about 50%, typically from about 2% to about 30%, and even more typically from about 2% to about 15%.

### Making the Paper Product

Embodiments of the disclosed paper product can be made by providing a base sheet and coating that base sheet with a marking-erasable coating. Some embodiments of the method for making the paper product further comprise calendering the base sheet or the paper product, as described above. The base sheet can comprise a base-sheet core and a base-sheet coating or, alternatively, can comprise only a base-sheet core. Embodiments of the method for making the paper product can comprise applying a base-sheet coating to a base-sheet core before applying the marking-erasable coating. In embodiments that comprise applying a base-sheet coating and applying a marking-erasable coating, the marking-erasable coating is applied after the base-sheet coating. For example, the marking-erasable coating typically is applied after the base-sheet coating has substantially set, such as following a drying process or a calendering process.

The marking-erasable coating can be applied at a variety of coating weights. In general, the marking-erasable coating is applied at a coating weight sufficient to make the paper product erasable. Higher coating weights generally diminish the influence of roughness, porosity, and other base sheet characteristics that are detrimental to erasability. Higher coating weights also tend to prevent pigment particles from being exposed on the surface of the paper product. The use of higher coating weights also has disadvantages. Marking-erasable coatings applied at higher coating weights are more likely to crack, are more expensive, and take longer to dry. To make embodiments of the paper product in which the base sheet does not comprise a base-sheet coating, the marking-erasable coating typically is applied at a greater coating weight than the coating weight used to make embodiments in which the base sheet does comprise a base-sheet coating. For example, in embodiments in which the base sheet comprises only a base-sheet core, the marking-erasable coating typically is applied at a dry coating weight varying from about 2 pounds per 3,000 ft² to about 15 pounds per 3,000 ft², typically from about 3 pounds per 3,000 f² to about 10 pounds per 3,000 ft², and even more typically from about 4 pounds per 3,000 ft³ to about 8 pounds per 3,000 ft². In embodiments in which the base sheet does comprise a base-sheet coating, the marking-erasable coating typically is applied at a dry coating weight varying from about 0.3 pounds per 3,000 ft² to about 8 pounds per 3,000 ft², typically from about 0.4 pounds per 3,000 ft² to about 6 pounds per 3,000 ft², and even more typically from about 0.5 pounds per 3,000 ft² to about 2 pounds per 3,000 ft². In some embodiments, the combined dry coating weight, including the base-sheet coating and the marking-erasable coating, varies from about 2 pounds per 3,000 ft² to about 20 pounds per 3,000 ft², typically from about 3 pounds per 3,000 ft² to about 15 pounds per 3,000 ft², and even more typically from about 4 pounds per 3,000 ft² to about 10 pounds per 3,000 ft².

Coatings, including base-sheet coatings and marking-erasable coatings, can be applied during or after the various drying or calendering steps in the manufacture of embodiments of the paper product. For example, one or more base-sheet coatings can be applied to hold down fibers, provide a smooth base-sheet surface, and increase the base sheet density. After the one or more base-sheet coatings have partially or fully dried, one or more marking-erasable coatings can be applied. In some disclosed embodiments, the sheet is calendered between one or more of the coating steps. The entire paper product also can be calendered after the final coating step. In a preferred embodiment, the marking-erasable coating is the final coating applied to the paper product and the paper product is calendered after applying the marking-erasable coating. This calendering step can be performed, for example, at pressures varying from about 100 pli to about 600 pli, typically from about 100 pli to about 400 pli, and even more typically from about 100 pli to about 300 pli. By way of theory, this final calendering step may even out irregularities in the marking-erasable coating and make the marking-erasable coating smoother.

As discussed above, some disclosed embodiments are designed so that applied ink will eventually become non-erasable. These embodiments typically have marking-erasable coatings with lower coating weights than embodiments designed to be erasable for longer periods or indefinitely. For example, in embodiments in which the base sheet comprises only a base-sheet core, the marking-erasable coating typically is applied at a dry coating weight varying from about 1 pound per 3,000 ft² to about 8 pounds per 3,000 ft², typically from about 1.5 pounds per 3,000 ft² to about 6 pounds per 3,000 ft², and even more typically from about 2 pounds per 3,000 ft² to about 4 pounds per 3,000 ft². In embodiments in which the base sheet does comprise a base-sheet coating, the marking-erasable coating typically is applied at a dry coating weight varying from about 0.3 pounds per 3,000 ft² to about 4 pounds per 3,000 ft², typically from about 0.4 pounds per 3,000 ft² to about 3 pounds per 3,000 ft², and even more typically from about 0.5 pounds per 3,000 ft² to about 1.5 pounds per 3,000 ft². In some embodiments, the combined dry coating weight, including the base-sheet coating and the marking-erasable coating, varies from about 2 pounds per 3,000 ft² to about 12 pounds per 3,000 ft², typically from about 2.5 pounds per 3,000 ft² to about 8 pounds per 3,000 ft², and even more typically from about 3 pounds per 3,000 ft² to about 6 pounds per 3,000 ft².

Base-sheet coatings and marking-erasable coatings can be applied with a coating apparatus selected to provide a particular coating weight. For small hand sheets, the coating weight can be adjusted, for example, by selecting an appropriate Mayer rod. For the large-scale coating processes, the coating apparatus can be a film-forming machine. The desired coating weight depends on the coating requirements and the physical properties of the coating material, such as the percent solids. The percent solids of the coating material, when applied, typically is between about 2% and about 40%.

### Applications

Embodiments of the paper product have many applications. For example, some disclosed embodiments are especially well suited for recording and displaying information during meetings and presentations. Other embodiments are especially well-suited for recording and displaying notes. In some disclosed embodiments, the marking-erasable coating is substantially transparent and the base sheet has markings that show through the marking-erasable coating.

For instruction, such as classroom instruction, some disclosed embodiments can be used as an alternative to chalk boards. Erasable markings on some embodiments of the paper product usually are more visible than erasable markings on chalk boards. In part, this is because chalk boards generally are dark colored and marked with light colored materials, whereas embodiments of the disclosed paper product can be light colored and marked with dark colored materials. Unlike chalk boards, embodiments of the disclosed paper product can be reversibly marked with liquid ink. In general, less force is required to mark a surface with a marking instrument that dispenses liquid ink than is required to mark a surface with a solid marking instrument, such as chalk. This may be due to the ability of liquid ink to lubricate the interface between the marking instrument and the surface. Another advantage of liquid ink is that, unlike chalk, it does not create dust when it is erased from a surface.

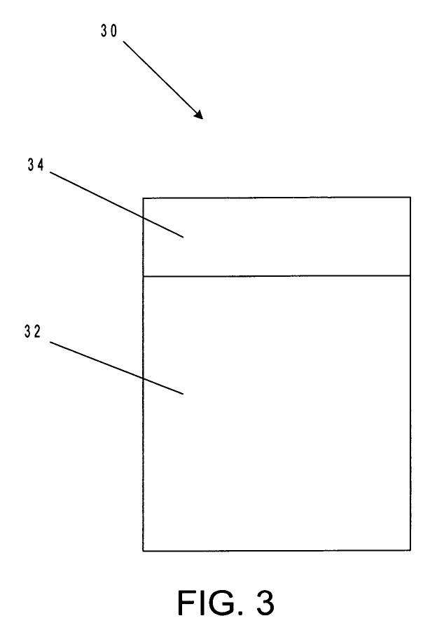

The disclosed paper product can be modified for various applications. For example, and without limitation, disclosed embodiments can be used in note paper products, calendars, daily planners, coloring books, and labels. FIG. 3 illustrates one example of a note paper product. The illustrated note paper product 30 comprises a first surface (not shown) and a second surface 32. The first surface comprises a marking-erasable coating. At least a portion, such as portion 34, of the second surface 32 includes an effective amount of an adhesive material, such as an adhesive material that can hold the note paper product to a surface and will not leave a residue when the note paper product is removed from that surface. Note paper products like the one illustrated in FIG. 3 can be assembled into pads.

The disclosed paper product also is well suited for applications requiring relatively large sheets of paper. For example, embodiments of the disclosed paper product can be incorporated into pads that are designed to be displayed on easels during presentations and meetings. The disclosed embodiments designed so that markings will eventually become permanent are especially well suited for this application. Easel pads incorporating this embodiment of the paper product can be marked and erased repeatedly and the remaining markings will eventually become permanent. The sheets on which the markings have become permanent then can be handled without risking erasure of the markings.

Embodiments of the disclosed paper product can be sold in kits with markers that are particularly well-suited for use with the paper product. For example, the paper product can be sold in a kit with a marker that leaves a mark that can be easily erased from the surface of the paper product. An eraser well suited for erasing marks left by the marker also can be included. As mentioned, some embodiments of the paper product are erasable when marked with a permanent marker or a dry erase marker, such as a dry erase marker containing alcohol. The marks left by a permanent marker typically can be erased most efficiently with a rubbery eraser, while the marks left by a dry erase marker can be erased easily with a dry cloth or felt-type chalk board eraser. Thus, some embodiments of the kit can include a permanent marker and a rubbery eraser or a dry erase marker and a soft eraser, such as a felt-type chalk board eraser.

### EXAMPLES

The following examples are provided to illustrate certain particular embodiments of the disclosure. It should be understood that additional embodiments not limited to the particular features described are consistent with the following examples.

### Example 1

In a constructed embodiment, a hot/soft calendered base sheet comprising a base-sheet core and a base-sheet coating was coated with a marking-erasable coating. The base sheet was a Boise food grade release base, obtained from Boise White Paper, LLC (Boise, Id.). The base-sheet coating comprised 70 parts fine number one clay, 30 parts ground calcium carbonate, 4 parts ethylated starch, and 12 parts latex. The marking-erasable coating, comprising a 3.5% solution of sodium alginate in water, was applied with a #3 Mayer rod at a dry coating weight of about 0.5 pounds per 3,000 ft². After the marking-erasable coating dried, the surface of the constructed embodiment was tested with several different solvent-based markers for erasability. The product demonstrated its ability to be erased several times while retaining the important characteristics of a paper product.

### Example 2

The paper product described in Example 1 was marked with a Sanford MAGNUM® permanent marker. The marks were erased with a rubbery eraser immediately after drying. The MD before erasing was 0.9 for a first mark and 1.15 for a second mark. The RMD after erasing was 0.06 for the first mark and 0.07 for the second mark.

### Example 3

This example describes the construction of several embodiments of an erasable paper product according to the present disclosure. These embodiments comprise a variety of components and were made with a variety of processing techniques.

Experimental Procedures

In embodiments comprising starch, the starch was prepared by the following method. First a calculated amount of water was added to a jacketed beaker. The dry starch then was added to the water. The mixture then was heated to 94° C. and maintained at that temperature for 20 minutes. The mixture then was poured into a container. At this time, the percent solids was calculated. The cooking procedure used for preparing polyvinylalcohol was exactly the same as that used for preparing starch.

Unlike starch and polyvinylalcohol, the cold water soluble chemicals, such as carboxymethylcellulose and sodium alginate, did not need to be heated. Latex and pre-dissolved chemicals were used as supplied or diluted with de-ionized water to a pre-determined percent solids.

The various coatings were applied with Mayer rods. Coating weight can be affected by many factors, but Mayer rods with higher numbers generally provide higher coating weights.

In order to test the erasability of the constructed embodiments, the embodiments were marked with EXPO® broad tip dry erase markers. After a drying period, such as a drying for a period between about 10 seconds and about 30 seconds, the markings were rubbed lightly with a facial tissue. The residual marker image was examined visually and also was measured by an X-Rite densitometer.

Smoothness and density were measured as Sheffield smoothness and Gurley density, respectively. The Gurley density tests were performed with a Lorentzen & Wettre Densitometer or a Hagerty Technologies Model 1 Air Permeability Tester. The Sheffield smoothness tests were performed with a Hagerty Technologies Model 538 Paper Smoothness Tester. Calendering was performed with a Beloit Lab calendering machine.

The Base Sheet

Embodiments of the paper product were constructed comprising several different base sheets. Coated base sheets were found to be preferable for promoting erasability, but suitable embodiments also were constructed with uncoated base sheets. In general, smoother and denser base sheets were found to promote erasability. For embodiments comprising a coated base sheet, it was found that base-sheet coatings having low coating porosity and high surface coverage promoted erasability.

Table 2 illustrates the residual marker density (RMD) of embodiments comprising several different base sheets in combination with several different marking-erasable coatings. As referenced in Table 2, marking-erasable coating 1 (MEC1) was a 20% solution of PENFORD® GUM-380 (hydroxyethylated starch) applied with a #6 Mayer rod; marking-erasable coating 2 (MEC2) was 10% solution of Wescote 3080 applied with a #6 Mayer rod; and marking-erasable coating 3 (MEC3) was a 3.5% sodium alginate solution applied with a #6 Mayer rod. Wescote 3080 is a carboxymethylated potato starch product manufactured by Western Polymers of Calgary, Alberta.

TABLE 2

| | Sheffield Smooth- | Gurley Density | MD Before | RMD with | RMD with | RMD with |
|---|---|---|---|---|---|---|
| Base Sheet | ness (cc/min) | (sec) | Erasing | MEC1 | MEC2 | MEC3 |
| 50 pounds per | 30.6 | 3,562 | 0.9 | 0.07 | 0.05 | 0.07 |
| 3,000 ft² FSDL | | | | | | |
| 51 pounds per | 54 | 5,885 | 0.9 | 0.08 | 0.11 | 0.16 |
| 3,000 ft² C1S | | | | | | |
| 3.2 Release Base | | | | | | |
| 70 pounds per | 73.1 | 2,795 | 0.86 | 0.07 | 0.06 | 0.09 |
| 3,000 ft² ARVL | | | | | | |
| Glassine | 117 | 18,300 | 0.32 | 0.14 | n/a | n/a |
| Paper | | | | | | |
| 50 pounds per | 41 | 3,942 | 1.2 | 0.95 | n/a | n/a |
| 3,000 ft² FSDL | | | | | | |
| Backside | | | | | | |

Glassine paper is not coated and has a high Gurley density (about 18,300 sec). Glassine paper is not especially smooth, with a Sheffield smoothness of 117. One embodiment comprising glassine paper coated with MEC1 was found to have a RMD comparable to the RMD of the embodiments comprising coated base sheets. It also was found that the RMD of the embodiments comprising glassine paper could be further decreased by increasing the thickness of the marking-erasable coating.

The Marking-Erasable Coating

Many different ingredients were incorporated into the marking-erasable coatings of constructed embodiments. Starches and starch-like chemicals were discovered to be well suited for incorporation into the marking-erasable coating. The starches evaluated included pearl corn starch, pea starch, ethylated starch, carboxyl methylated starch, cationic potato starch, styrene butadiene grafted starch, and modified food grade tapioca starch. Cellulose and cellulose derivatives are molecularly similar to starch and, as expected, also proved to be well suited for creating an erasable surface. The cellulose derivatives evaluated were carboxymethylcellulose and hydroxyethylcellulose.

Highly charged ionic polymers and oligomers, both anionic and cationic, also were evaluated as ingredients in the marking-erasable coating. Several chemicals in this class, including sodium alginate and two commercially available polymer products, were found to be effective at promoting erasability. The commercially available polymer products were Dispex-N40, which comprises anionic lower molecular weight acrylic acid sodium salts and Agefloc-WT40, which comprises low molecular weight cationic polymers. Dispex-N40 and Agefloc-WT40 are available from Ciba Specialty Chemicals Corp. of Suffolk, Va.

Making the Paper Product

In a first set of trials, several variables were adjusted during the construction of embodiments of the paper product. The constructed embodiments then were tested for RMD. Two base-sheet coating mixtures were prepared and applied to uncoated base sheets (42 pounds per 3,000 ft²) at several different dry coating weights. The coated base sheets then were hot/soft calendered with different calendering pressures and coated with a marking-erasable coating (MEC) comprising 20% PENFORD® GUM-380 (hydroxyethylated starch) applied with a #6 Mayer rod. The RMD for each of these constructed embodiments is shown in Table 3. Two of these constructed embodiments then were calendered a second time. Table 3 shows the RMD for these twice-calendered embodiments.

TABLE 3

| Base-Sheet | Coating Weight | Calen- | | Sheffield | Gurley | RMD After | RMD After Applying |
|---|---|---|---|---|---|---|---|
| Coating | (pounds per | dering | | Smoothness | Density | Applying | the MEC and then |
| Type | 3,000 ft²) | Pressure | | (cc/min) | (sec) | the MEC | Calendering at 750 psi |
| 46-1 | 7.29 | 0 | psi | 172.3 | 827 | 0.09 | n/a |
| 46-1 | 7.29 | 250 | psi | 35.5 | 1416 | 0.07 | 0.03 |
| 46-1 | 7.29 | 500 | psi | 33.4 | 1875 | 0.07 | n/a |
| 46-2 | 12.3 | 0 | psi | 161.7 | 257.7 | 0.18 | 0.07 |
| 46-2 | 12.3 | 500 | psi | 30 | 366.6 | 0.1 | n/a |
| 46-2 | 12.3 | 1,000 | psi | 22 | 520.8 | 0.1 | n/a |

Table 3 illustrates the effect of different coating weights for the base-sheet coating, the effect of different calendering pressures for the calendering step that occurs prior to the application of the marking-erasable coating, and the effect of calendering a second time after applying the marking-erasable coating. Base-sheet coating type 46-2, which comprises only pigment (ground calcium carbonate), was much more porous and less dense than base-sheet coating type 46-1, which comprised a combination of #1 clay and ground calcium carbonate. The RMDs for the embodiments comprising base-sheet coating type 46-2 also were higher than the RMDs for the embodiments comprising base-sheet coating type 46-1. This trial established that base-sheet coating porosity and base-sheet density can significantly affect the erasability of the paper product.

As seen in Table 3, calendering the base sheet at higher pressures increases the base-sheet density and improves erasability. Calendering after applying the marking-erasable coating was found to have a significant effect on erasability. By way of theory, this effect may be due to increased smoothness.

In a second set of trials, uncoated base sheets (42 pounds per 3,000 ft²) were coated with a base-sheet coating applied at different coating weights and then coated with a marking-erasable coating. In Table 4, the referenced marking-erasable coating 1 (MEC1) comprised 20% PENFORD® GUM-380 (hydroxyethylated starch) and was applied with a #6 Mayer rod; marking-erasable coating 2 (MEC2) comprised 10% PENFORD® GUM-380 (hydroxyethylated starch) and was applied with a #3 Mayer rod. The sheets were not calendered after the applying the base-sheet coating or after applying the marking-erasable coating. As shown in Table 4, higher coating weights for the base-sheet coating or the marking-erasable coating improved the erasability of the paper product. By way of theory, higher coating weights may lead to higher sheet densities and better surface coverage, both of which contribute to improved erasability.

TABLE 4

| | Coating | | | | |
|---|---|---|---|---|---|
| Base-Sheet | Weight | Sheffield | Gurley | RMD | RMD |
| Coating | (pounds per | Smoothness | Density | with | with |
| Type | 3,000 ft²) | (cc/min) | (sec) | MEC1 | MEC2 |
| 46-1 | 3.52 | 168.7 | 51.5 | 0.14 | 0.31 |
| 46-1 | 4.98 | 180.9 | 109.4 | 0.11 | 0.29 |
| 46-1 | 5.81 | 206.2 | 275.8 | n/a | 0.16 |
| 46-1 | 6.52 | 146 | 483.7 | 0.14 | 0.12 |
| 46-1 | 7.29 | 162.1 | 575.6 | 0.1 | 0.12 |
| 46-1 | 8.52 | 199.1 | 718 | 0.09 | 0.1 |
| 46-2 | 12.3 | 161 | 257 | 0.18 | 0.85 |

In a third set of trials, uncoated base sheets (42 pounds per 3,000 ft²) were calendered at different calendering pressures to obtain different levels of density and smoothness. The calendered base sheets then were coated with a marking-erasable coating at a dry coating weight of about 1 pound per 3,000 ft². All of the embodiments constructed in this manner had unacceptable RMDs. Glassine paper also was tested as the base sheet and, as discussed above, produced an embodiment with a RMD closer to the RMDs achieved by embodiments comprising coated base sheets. The results of this set of trials are shown in Table 5.

TABLE 5

| | | | Sheffield | Gurley | |
|---|---|---|---|---|---|
| Base Sheet | Calendering | | Smoothness | Density | |
| Type | Pressure | | (cc/min) | (sec) | RMD |
| 42 pounds per | 0 | psi | 190 | 41 | 0.36 |
| 3,000 ft² | | | | | |
| 42 pounds per | 1,000 | psi | 82 | 94 | 0.29 |
| 3,000 ft² | | | | | |
| 42 pounds per | 1,500 | psi | 73 | 125 | 0.27 |
| 3,000 ft² | | | | | |
| 42 pounds per | 2,500 | psi | 68 | 180 | 0.25 |
| 3,000 ft² | | | | | |

| | | | | |
|---|---|---|---|---|
| Glassine | n/a | 117 | 18,300 | 0.14 |
| Paper | | | | |

In a fourth set of trials, uncoated base sheets (42 pounds per 3,000 ft²) were coated with marking-erasable coatings at higher coating weights than the coating weights used in the previous trials. The marking-erasable coatings comprised a modified starch and NUSURF in different ratios. NUSURF is a large particle size delaminated clay product available from J.M. Huber Corp. of Edison, N.J. The marking-erasable coatings were applied at several different coating weights. The results of this set of trials are shown in Table 6. The results show that it is possible to produce acceptable embodiments of the erasable paper product with marking-erasable coatings applied to uncoated base sheets.

TABLE 6

| | Coating | | |
|---|---|---|---|
| | Weight | | RMD with |
| Modified | (pounds per | RMD with no | Calendering at |
| Starch/NUSURF | 3,000 ft²) | Calendering | 1250 psi |
| 85/15 | 4.35 | n/a | 0.12 |
| 85/15 | 5.19 | 0.16 | 0.08 |
| 85/15 | 5.82 | n/a | 0.06 |
| 80/20 | 5.23 | 0.2 | 0.07 |
| 80/20 | 6.6 | n/a | 0.07 |
| 50/50 | 6.99 | n/a | 0.26 |

### Example 4

This example describes an oil and grease test for an embodiment of the disclosed paper product with a marking-erasable coating comprising sodium alginate for oil and grease resistance using the 3M oil and grease resistance test kit.

The sample was placed on a clean surface, test side up. The tester was careful not to touch the area to be tested. A drop of each test kit solution, as shown in Table 1, was dropped onto the sample from a height of about one inch. After exactly 15 seconds, the excess fluid was removed with a clean swatch of cotton cloth or tissue. The test areas then were examined. Failure was evidenced by a pronounced darkening of the test area caused by penetration of the solution. This procedure was repeated with each of the test kit solutions.

In several trials, no penetration was detected using test kit solutions 1 through 9 or 1 through 10. In comparison to conventional paper products, the tested samples demonstrated excellent oil and grease resistance.

Other embodiments of the invention will be apparent to those of ordinary skill in the art from a consideration of this specification, or practice of the invention disclosed herein. It is intended that the specification and examples be considered as exemplary only, with the true scope and spirit of the invention being indicated by the following claims.

1. A paper product having a base sheet and a marking-erasable coating, where the marking-erasable coating is water-soluble or water dispersible.

2. The paper product of claim 1, where the paper product is substantially recyclable or substantially repulpable.

3. The paper product of claim 1, where the marking-erasable coating is substantially continuous.

4. The paper product of claim 1, configured so that liquid ink from a black dry erase marker can be applied to the surface of the paper product, allowed to dry, and then erased with a dry cloth, where the liquid ink has a marker density greater than about 0.5 after drying and a residual marker density less than about 0.1 after being erased.

5. The paper product of claim 1, where the marking-erasable coating comprises an ingredient selected from the group consisting of starch, cellulose, a charged polymer, a derivative thereof, and mixtures thereof.

6. The paper product of claim 1, where the marking-erasable coating comprises pearl corn starch, pea starch, ethylated starch, carboxyl methylated starch, cationic potato starch, styrene butadiene grafted starch, modified food grade tapioca starch, carboxymethylcellulose, hydroxyethylcellulose, sodium alginate, polyvinyl alcohol, or mixtures thereof.

7. The paper product of claim 1, where the marking-erasable coating comprises at least one starch.

8. The paper product of claim 1, where the marking-erasable coating comprises greater than about 50% starch by dry weight.

9. The paper product of claim 1, where the paper product has a Gurley density greater than about 1,000 seconds.

10. The paper product of claim 1, where the surface of the paper product has a Sheffield smoothness less than about 200 cubic centimeters per minute.

11. The paper product of claim 1, where the marking-erasable coating is present in an amount sufficient to make the paper product erasable.

12-13. (canceled)

14. The paper product of claim 1, where the base sheet comprises:
a base-sheet core, comprising a network of fibers; and
a base-sheet coating, comprising a pigment and a binder.

15-16. (canceled)

17. The paper product of claim 14, where the marking-erasable coating comprises less than about 30% pigment by dry weight.

18. The paper product of claim 1, where the base sheet comprises a base-sheet core and there is no base-sheet coating between the base-sheet core and the marking-erasable coating.

19-21. (canceled)

22. The paper product of claim 1, where the marking-erasable coating has a substantially continuous surface that contains substantially no surface-exposed pigment particles.

23-24. (canceled)

25. A method for making a paper product, comprising applying a marking-erasable coating to a base sheet, where the marking-erasable coating is water-soluble or water dispersible.

26. The method of claim 25, further comprising calendering the paper product after applying the marking-erasable coating until the paper product has a Gurley density greater than about 1,000 seconds.

27. The method of claim 25, further comprising calendering the paper product after applying the marking-erasable coating until the paper product has a Sheffield smoothness less than about 200 cubic centimeters per minute.

28-29. (canceled)

30. The method of claim 25, where the marking-erasable coating is applied at a coating weight sufficient to make the paper product erasable.

31. (canceled)

32. The method of claim 25, where the base sheet comprises:
a base-sheet core, comprising a network of fibers; and
a base-sheet coating, comprising a binder.

33. (canceled)

34. The method of claim 25, where the base sheet does not comprise a base-sheet coating and no base-sheet coating is applied before applying the marking-erasable coating.

35. (canceled)

36. A kit, comprising:
a paper product, comprising a base sheet and a marking-erasable coating, where the marking-erasable coating is water-soluble or water dispersible; and
a writing instrument that can be used to create erasable marks on the paper product.

37. The kit of claim 36, further comprising an eraser that can be used to erase marks made on the paper product by the writing instrument.

38. A note paper product, comprising a sheet having a first surface and a second surface, where at least a portion of the second surface is covered with an adhesive material, the sheet comprises a base sheet and a marking-erasable coating, and the marking-erasable coating is water-soluble or water dispersible.
